(19) United States
(12) Patent Application Publication
(10) Pub. No.: US 2006/0092096 A1
(43) Pub. Date: May 4, 2006

(54) Display apparatus and display method

(75) Inventor: Yukihiko Sakashita, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/257,712

(22) Filed: Oct. 25, 2005

(30) Foreign Application Priority Data
Oct. 28, 2004 (JP) 2004-314050

(51) Int. Cl. G09G 5/00; H04N 3/26

(52) U.S. Cl. 345/1.3; 348/745

(57) ABSTRACT

A three-panel projection apparatus in which display quality due to displacements of fixing positions of panels is improved is provided. By displaying position-adjusting-images of a plurality of colors formed in a plurality of different patterns and by selecting any of the patterns, the overall display frame is compensated for with a method corresponding to the selected adjusting images and displayed. Further, at least two of the adjusting images are arranged on the opposing corners of the display frame. Still further, the compensating method performs computation on the basis of a target pixel and its circumferential pixels so as to form a compensation pixel.

### BACKGROUND OF THE INVENTION

1. Field of the Invention

The present invention relates to a display apparatus, and more particularly, it relates to a display apparatus synthesizing images displayed on a plurality of display devices and displaying the synthesized one.

2. Description of the Related Art

In a known method for adjusting a display position, a panel and the like are mechanically moved (e.g., see Japanese Patent Laid-Open No. 7-59037, corresponding to U.S. Pat. No. 5,592,239).

Also, in a known electrical method for adjusting the display position, the display position in the X and Y directions is adjusted, for example, by changing a drive timing of the panel.

While these methods are suitable for adjustment to be performed, for example, upon factory shipment (upon production), or by a service person (upon repair), unfortunately, an operator has difficulty in implementing them.

While displacement of the display position in the X and Y directions can be mechanically compensated for while looking at the corresponding display image, rotational displacement of the display cannot be manually corrected since two parameters of its rotational angle and rotation center must be adjusted at the same time.

While being possible in the X and Y directions, the adjustment by changing a drive timing is impossible in the rotational direction.

In recent years, in a projection display apparatus including, for example, a digital micromirror device (DMD), a transmissive thin film transistor (TFT), liquid crystal on silicon (LCOS), a single pixel has a size of about 10 to 20 μm due to development of a higher resolution of its panel. As a result, mechanical alignment of the positions of R, G, and B panels upon synthesizing their display images is difficult. Hence, an easier adjusting method is required.

Also, displacement of the fixed position of the display panel due to change over time after shipment sometimes causes its display position to be displaced. Hence, a method allowing an operator to easily adjust the position of the panel is required.

### SUMMARY OF THE INVENTION

The present invention is directed to a display apparatus allowing an operator to simply, easily, and quickly adjust displacement of its display panel.

Even when mechanical adjustment of the displacement becomes more difficult because of future advancement of more densely packaging of the panel, a display apparatus allowing the displacement to be adjusted is provided.

In accordance with one aspect of the present invention, a display apparatus includes an adjusting-image display unit displaying, on a display frame, position-adjusting-images of a plurality of colors formed in a plurality of different patterns; a selecting unit facilitating selecting any of the patterns; and a compensating unit compensating for display positions of images in accordance with the adjusting images selected by the selecting unit.

As described above, according to the present invention, since position-adjusting-images of a plurality of colors formed in a plurality of different patterns are displayed and any of the patterns is selected, an image is compensated for in accordance with the selected adjusting image and is displayed, thereby achieving a display apparatus in which deterioration in image quality caused by relative displacement of panels is prevented with easier adjustment.

In one embodiment, the display apparatus further includes an arranging unit arranging at least two of the adjusting images on opposing corners of the display frame.

Also, according to the present invention, at least two of the adjusting images are arranged on opposing corners of the display frame, thereby achieving a display apparatus in which deterioration in image quality caused by relative rotational displacement of panels is prevented with easier adjustment.

In one embodiment, the compensating unit includes a computing unit computing information regarding display displacement of images on the basis of a target pixel and circumferential pixels of the target pixel, and a compensation-pixel forming unit forming a compensation pixel.

In addition, according to the present invention, with the foregoing compensating method, computation for information regarding display displacement of images is performed on the basis of a target pixel and circumferential pixels of the target pixel, and a compensation pixel is formed, thereby achieving a display apparatus having a high-quality compensation image subjected to little generation of jaggies and the like caused by displacement within a single pixel or rotational displacement.

In one embodiment, the display apparatus further includes a rotational-angle computing unit computing a rotational angle on the basis of the at least two selected patterns displayed on the display frame; and a rotation-compensating display unit compensating for a display image by rotating and displaying the display image.

Further, according to the present invention, since a rotational angle is computed on the basis of the at least two selected patterns displayed on the display frame and a display image is compensated by rotation and displayed, the rotational angle is easily computed, thereby achieving a display apparatus preventing deterioration in image quality with easier adjustment even when a display panel is rotationally displaced.

Further features of the present invention will become apparent from the following description of exemplary embodiments with reference to the attached drawings.

### BRIEF DESCRIPTION OF THE DRAWINGS

FIG. 1 is a schematic side view of a rear-projection display apparatus according to a first embodiment of the present invention.

FIG. 2 is a schematic sectional view of a projection display engine according to the first embodiment.

FIG. 3 is a block diagram of the image display apparatus according to the first embodiment.

FIGS. 4A to 4C are schematic diagrams of example display images according to the first embodiment.

FIG. 5 is a schematic diagram of other example display images according to the first embodiment.

FIGS. 6A to 6C are schematic diagrams of other example display images according to the first embodiment.

FIG. 7 is a schematic diagram of other example display images according to the first embodiment.

FIG. 8 is a schematic diagram of another example display image according to the first embodiment.

FIG. 9 is a schematic diagram of example display of an adjusting image according to the first embodiment.

FIG. 10 is a schematic diagram of example display of another adjusting image according to the first embodiment.

FIG. 11 is a schematic diagram of example display of another adjusting image according to the first embodiment.

FIG. 12 is a schematic diagram of another example display image according to the first embodiment.

FIG. 13 is a schematic diagram of an example compensation image according to the first embodiment.

FIG. 14 is a schematic diagram of example display of projected images according to a second embodiment.

### DESCRIPTION OF THE EMBODIMENTS

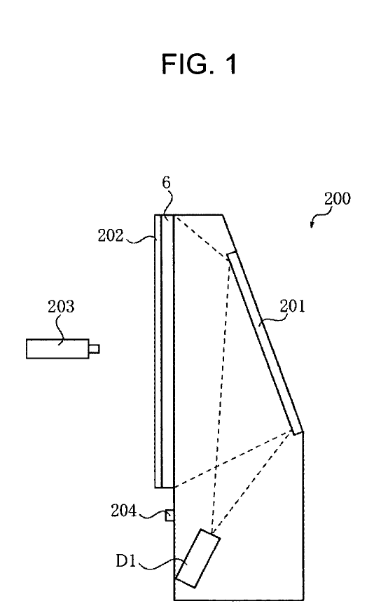

FIG. 1 is a side view of a rear-projection display apparatus 200 according to a first embodiment of the present invention.

An image projected from a projection display engine D1 is reflected at a reflective mirror 201 and projected onto a screen 6 from its rear surface. The screen 6 has a digitizer 202 fixed in front thereof, and position coordinates inputted from the front surface of the screen 6 with a digitizer pen 203 is inputted into the display apparatus 200. Any one of a variety of types including an optical type, a pressure sensitive type, and an ultrasonic type can be used as the digitizer.

A display-position adjusting SW 204 is used for instructing start of aligning adjustment.

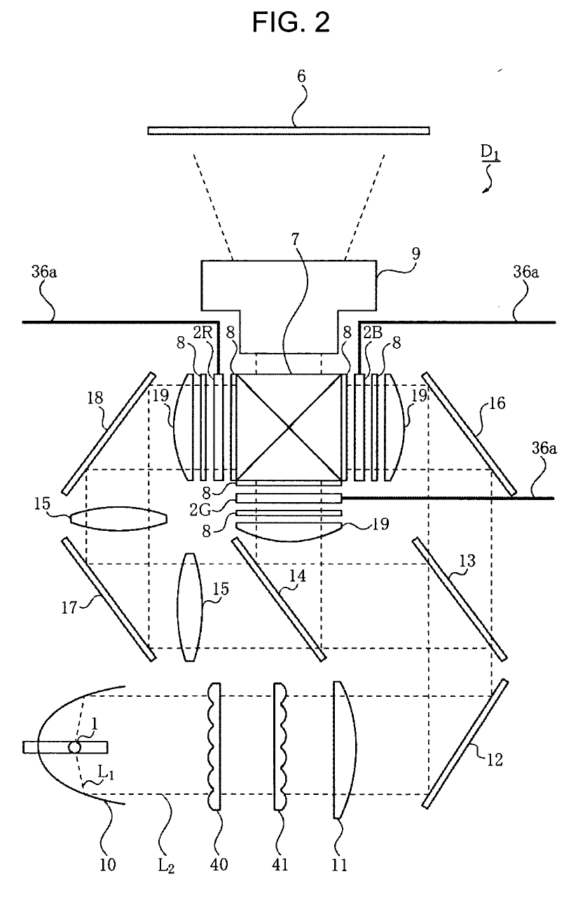

As shown in FIG. 2, the projection display engine D1 includes three liquid crystal panels 2R, 2G, and 2B corresponding to respective red (R), green (G), and blue (B) display colors so as to serve as optical modulating devices, and each of these three liquid crystal panels 2R, 2G, and 2B is arranged so as to face a cross prism 7. In the present embodiment, each of the liquid crystal panels 2R, 2G, and 2B is composed of twisted nematic (TN) liquid crystal and driven by a thin film transistor (TFT). Also, each of the liquid crystal panels 2R, 2G, and 2B has polarizing plates 8 arranged on both side thereof so as to be sandwiched by the corresponding polarizing plates. The cross prism 7 has a projection lens 9, and the screen (member to be projected) 6 is arranged on the light-emitting side thereof.

A lamp (light source) 1 has a parabolic reflector 10 surrounded thereby so that light emitted from the lamp 1 is converted into parallel light fluxes. The reflector 10 may have an elliptical shape instead of the parabolic shape so as to convert the emitted light into condensed light fluxes. As the lamp 1, a metal halide lamp, a xenon lamp, or the like can be employed.

The lamp 1 has fly-eye integrators 40 and 41 arranged on the optical path of light emitted therefrom such that the fly-eye integrators 40 and 41 have conjugate relations with the liquid crystal panels 2R, 2G, and 2B so as to improve unevenness of the emitted light.

Also, the fly-lens integrators 40 and 41 have a relay lens 11 and a mirror 12 arranged one after another on the light emitting side thereof. Also, two dichroic mirrors 13 and 14 are arranged so as to split the emitted light from the lamp 1. A relay lens 15 and mirrors 16, 17 and 18 are arranged so as to introduce the split light to the liquid crystal panels 2R, 2G, and 2B via respective field lenses 19.

When each of the liquid crystal panels 2R, 2G and 2B is not properly positioned, a display image has deteriorated image quality as will be described later.

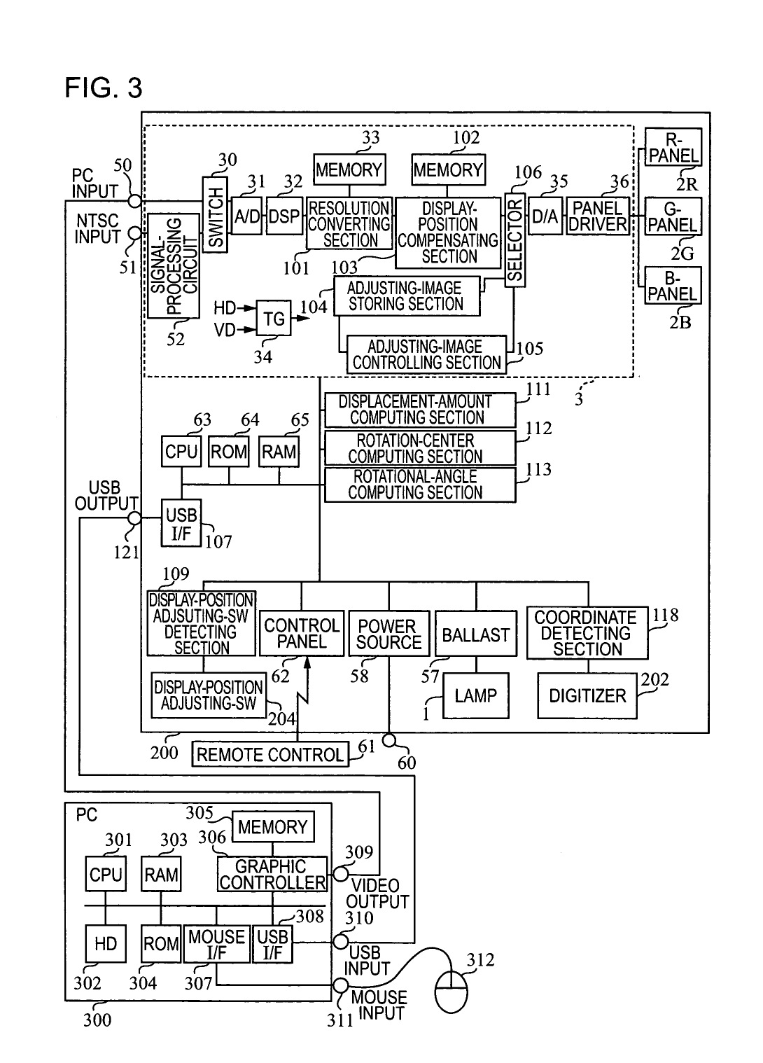

As shown in FIG. 3, the foregoing liquid crystal panels 2R, 2G, and 2B have a video-signal processing unit 3 and so forth connected thereto.

FIG. 3 is a block diagram of the rear-projection display apparatus 200 according to the first embodiment, which will be described below in detail.

The video-signal processing unit 3 includes a switch 30, an A/D converter 31, a digital signal processing (DSP) section 32, a memory 33 storing present display data and data to be displayed in the following frame, and so forth, a timing generator 34, a resolution converting section 101, a memory 102 storing display data used for compensating for a display position, a display-position compensating section 103, an adjusting-image storing section 104, an adjusting-image controlling section 105, a selector 106, a D/A converter 35, and a driver circuit 36 supplying a signal and power to each liquid crystal panel.

The DSP section 32 performs display image processing of, for example, contrast and brightness adjustment, and color conversion of the display image.

The display apparatus 200 includes a personal computer (PC) input terminal 50 and a National Television System Committee (NTSC) input terminal 51.

While terminals only for analogue input signals are present in the block diagram, one skilled in the art will appreciated that, even when input terminals used for a low voltage differential signal (LVDS), a transmission minimized differential signaling (TMDS) and the like, and terminals such as a digital TV-use terminal are provided, the present embodiment is effective.

Also, the display apparatus 200 includes a signal processing circuit 52 performing signal processing, for example, decoding of NTSC signals, noise-reduction processing, band-limiting filtering, and signal-level adjusting.

Also, the display apparatus 200 includes a ballast 57 serving as a lamp-use power source connected to the lamp 1, a system power source 58, and an AC inlet 60.

Further, the display apparatus 200 includes a remote control 61 for performing a variety of operations thereof, and a control panel 62 receiving a signal from the remote control.

Still further, the display apparatus 200 includes the display-position adjusting-SW 204, a display-position adjusting-SW detecting section 109 detecting an operation of the display-position adjusting-SW 204, a coordinate-detecting section 118 detecting coordinates instructed by a digitizer 202, a displacement-amount computing section 111, a rotation-center computing section 112, a rotational-angle computing section 113, and a USB interface (I/F) 107.

In addition, the display apparatus 200 includes a central processing unit (CPU) 63, a read only memory (ROM) 64, and a random access memory (RAM) 65. The CPU 63 is connected to the video-signal inputting unit 3, the control panel 62, the ballast 57, the display-position adjusting-SW detecting section 109, the coordinate-detecting section 118, the displacement-amount computing section 111, the rotation-center computing section 112, the rotational-angle computing section 113, the USB I/F 107, and so forth. The CPU 63, for example, controls drive of the liquid crystal panels 2R, 2G, and 2B, and the lamp 1, magnifies/reduces, and moves a display image. At the same time, the CPU 63 controls displaying a display-position adjusting-image, and controls computing a displacement amount of the display image.

While the display-position adjusting-SW detecting section 109, the coordinate-detecting section 118, the displacement-amount computing section 111, the rotation-center computing section 112, the rotational-angle computing section 113, the USB I/F 107, and the like are connected to the CPU 63 in the present embodiment, these may be built in the CPU or configured so as to be executable with a program.

The display apparatus 200 has a personal computer (PC) 300 connected thereto. The PC 300 includes a CPU 301, a hard disk (HD) 302, a RAM 303, a ROM 304, a video memory 305, a graphic controller 306, a mouse I/F 307, a USB I/F 308, a video output terminal 309, a USB input terminal 310, a mouse input terminal 311, and a mouse 312 connected to the mouse input terminal 311.

An effect of displacement of a panel exerted on a display characteristic will be described.

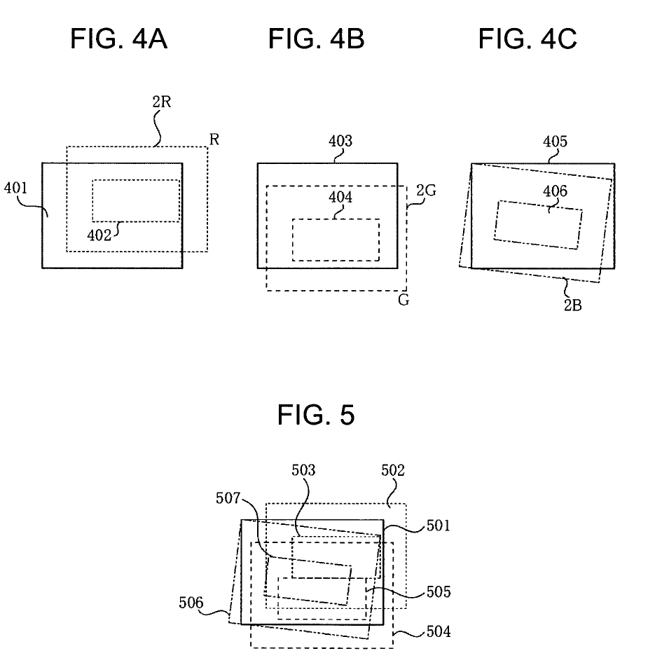

FIGS. 4A, 4B, and 4C are schematic diagrams of example display images of the respective panels, each fixed at a position displaced relative to its target fixing position. As shown in FIG. 4A, the R-panel 2R is fixed at a position displaced relative to its target fixing position 401. A rectangular image 402 is displayed on the R-panel 2R.

As shown in FIG. 4B, the G-panel 2G is fixed at a position displaced relative to its target fixing position 403. A rectangular image 404 is displayed on the G-panel 2G.

As shown in FIG. 4C, the B-panel 2B is fixed at a position displaced relative to its target fixing position 405. A rectangular image 406 is displayed on the B-panel 2B.

When the images displayed on the panels fixed at the displaced positions relative to the respective target fixing positions as described above are projected onto the screen 6, the display images of the three R-, G-, and B-panels after three panel synthesis are displaced in accordance with the displacements of the corresponding panels as shown in FIG. 5. Regarding reference numbers appearing in FIG. 5, 501 denotes a target display position at which, when the R-, the G- and the B-panels are fixed at respective target positions, their synthesized image is displayed on the screen, 502 denotes a screen display image of the R-panel, 503 denotes a screen display image of the rectangular image displayed on the R-panel, 504 denotes a screen display image of the G-panel, 505 denotes a screen display image of the rectangular image displayed on the G-panel, 506 denotes a screen display image of the B-panel, and 507 denotes a screen display image of the rectangular image displayed on the B-panel. Since the R-, G-, and B-rectangular images are displayed in a displaced manner in accordance with the displacements of the respective fixing positions, resulting in deteriorated image quality of the display images.

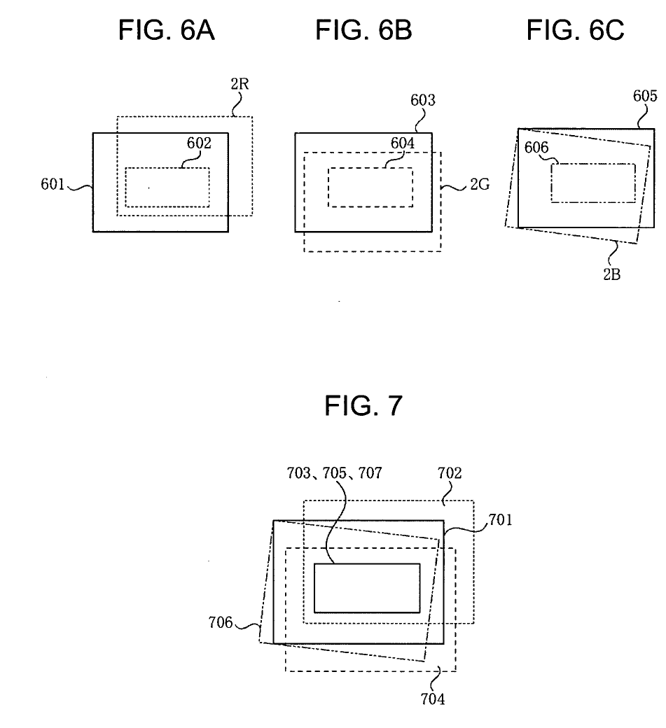

FIGS. 6A, 6B, and 6C are schematic diagrams of example display images of the respective panels, each electrically compensated for in accordance with the corresponding displacement information after detection of its displaced position.

As shown in FIG. 6A, the R-panel 2R is fixed at a position displaced relative to its target fixing position 601. A rectangular image 602 is compensated for in accordance with an amount of its displacement from the target fixing position and displayed on the R-panel 2R.

As shown in FIG. 6B, the G-panel 2G is fixed at a position displaced relative to its target fixing position 603. A rectangular image 604 is compensated for in accordance with an amount of its displacement from the target fixing position and displayed on the G-panel 2G.

As shown in FIG. 6C, the B-panel 2B is fixed at a position displaced relative to its target fixing position 605. A rectangular image 606 is compensated for in accordance with an amount of its displacement from the target fixing position and displayed on the B-panel 2B.

By compensating for displacement of display on each panel in accordance with the displacement as shown in FIG. 6, the displacement of each of the R-, G-, and B-display images after three-panel synthesis is reduced as shown in FIG. 7.

Regarding reference numbers appearing in FIG. 7, 701 denotes a target display position at which a synthesized image is displayed on the screen when the R-panel, the G-panel, and the B-panel are fixed at the respective target fixing positions; 702 denotes a screen display image of the R-panel; 703 denotes a screen display image of a rectangular image displayed on the R-panel; 704 denotes a screen display image of the G-panel 2G; 705 denotes a screen display image of a rectangular image displayed on the G-panel 2G, wherein the screen display image 705 is displayed on the same position as that of the rectangular image 703 on the R-panel; 706 denotes a screen display image of the B-panel 2B; and 707 denotes a screen display image of the rectangular image displayed on the B-panel 2B, wherein the screen image 707 is displayed at the same position as those of the rectangular images 703 and 705 on the R- and G-panels 2R and 2G.

As described above, by compensating for displacement of display on each panel in accordance with the displacement, the displacement of each of the display images of the three R-, G-, and B-panels after three-panel synthesis is reduced, thereby preventing deterioration in image quality.

An adjusting method according to another embodiment will be described in detail.

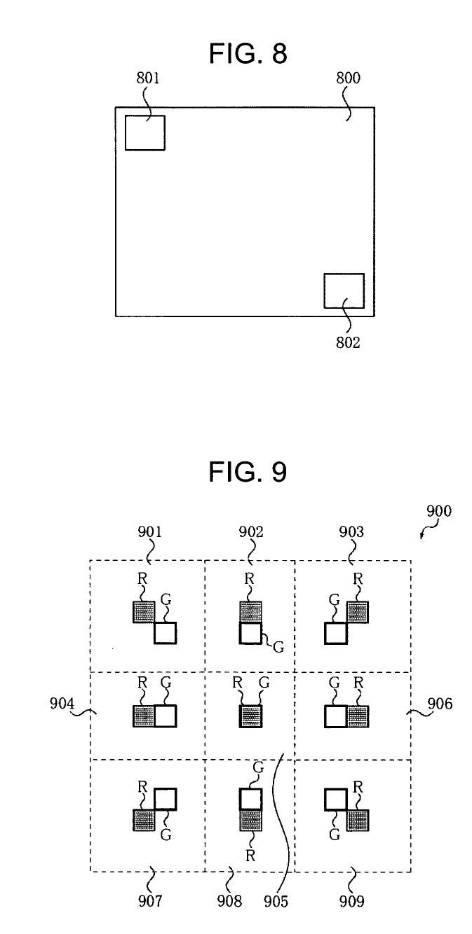

As shown in FIG. 8, a display frame 800 is projected onto a screen, and adjusting images 801 and 802 are respectively displayed on the upper left and lower right parts of the display frame 800.

Upon pushing the position detecting-SW 204 (instead of the detecting SW, an operating sequence diagram (OSD) may be displayed on the display frame), the position detecting-SW detecting section 109 detects that the position detecting-SW 204 has been pushed.

Then, adjusting images are read from the adjusting-image storing section 104 and displayed on opposing two corners of the display frame 800 with the adjusting-image controlling section 105 so as to serve as the adjusting images 801 and 802.

The adjusting images 801 and 802 represent images of R and B displaced with respect to a G point, by a single pixel in each of the vertical, horizontal, and oblique directions.

FIG. 9 illustrates a position-adjusting-image 900 for the G-panel and the R-panel, having nine kinds of patterns 901 to 909. In the pattern 901, an R-image is displaced in the upper-left direction by a single pixel relative to a G-image; in the pattern 902, an R-image is displaced directly upwards by a single pixel relative to a G-image; in the pattern 903, an R-image is displaced in the upper-right direction by a single pixel relative to a G-image; in the pattern 904, an R-image is displaced leftwards by a single pixel relative to a G-image; in the pattern 905, R- and G-images coincide with each other; in the pattern 906, an R-image is displaced rightwards by a single pixel relative to a G-image; in the pattern 907, an R-image is displaced in the lower-left direction by a single pixel relative to a G-image; in the pattern 908, an R-image is displaced downwards by a single pixel relative to a G-image; and in the pattern 909, an R-image is displaced in the lower-right direction by a single pixel relative to a G-image.

Likewise, adjusting images for the G-panel and the B-panel can be prepared by replacing R-images with corresponding B-images in FIG. 9.

When these adjusting images are displayed on the screen, images formed by overlapping the R- and G-images or the B- and G-images with one another and appearing optimal are different from each other in accordance with displacements of positions at which the corresponding panels are practically fixed.

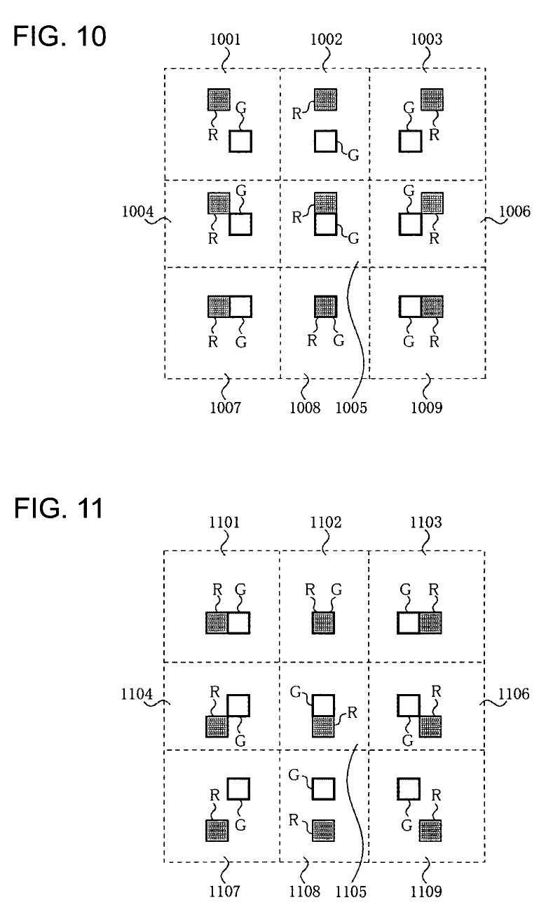

For example, when, in the adjusting image 801 displayed on the upper left part of the display frame 800 projected onto the screen 6, an image 1008 representing the pattern 908 having the R-image therein displaced downwards by a single pixel relative to the G-image as shown in FIG. 10 is optimal, the upper left part of the R-panel is displaced by a single pixel relative to the G-panel.

On this occasion, when, in the adjusting image 802 displayed on the opposing lower right part, the image 1008 representing the pattern 908 having the R-image therein displaced downwards by a single pixel relative to the G-image as shown in FIG. 10 is optimal, the lower right part of the R-panel is also displaced upwards by a single pixel relative to the G-panel, resulting in upward displacement of the overall R-panel by a single pixel.

On the contrary, when an image 1102 representing the pattern 908 having the R-image therein displaced upwards by a single pixel relative to the G-image as shown in FIG. 11 is optimal, the upper right part of the R-panel is displaced downwards by a single pixel relative to the G-panel, resulting in clockwise rotation of the R-panel relative to the G-panel.

An optimal pattern of each adjusting image is selected by the digitizer or the remote control.

On the basis of the selected pattern, an amount of displacement of the adjusting image is computed by the displacement-amount computing section 111 as described above. When the adjusting image is rotationally displaced, the rotation center and the rotational angle of the adjusting image are respectively computed by the rotation-center computing section 112 and the rotational-angle computing section 113, and an interpolation signal to be displayed on each panel is computed by the display-position compensating section 103.

A method for computing the rotational angle on the basis of these pieces of displacement information and the interpolation signal to be displayed on each panel will be described.

The rotational angle is obtained on the basis of a kind of the pattern selected for the adjusting images 801 and 802 displayed on the opposing corners of the display frame 800.

The selection of the patterns is carried out by the digitizer 202 or the remote control 61.

When the selection is carried out by the digitizer 202, the most optimally appearing patterns in the adjusting images 801 and 802 displayed on the display frame 800 on the screen 6 are selected by the digitizer pen 203. On the basis of the selected patterns, an amount of the displacement is obtained and the rotational angle is computed. When the selected patterns in the adjusting images 801 and 802 indicate the same direction and the same amount of displacement as each other, it is known that the displacement occurs in the X and Y directions without rotation. On the contrary, when the two selected patterns do not indicate the same direction as each other, it is known that the rotational displacement occurs.

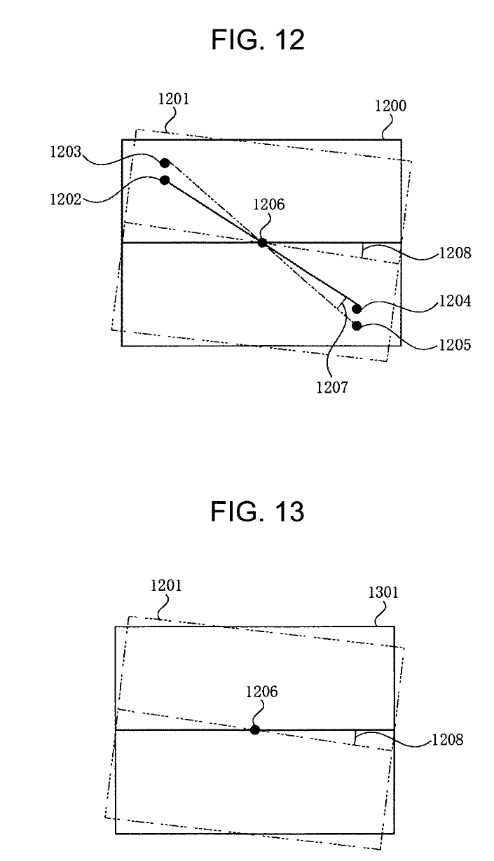

Regarding reference numbers shown in FIG. 12, 1200 denotes a display image of the G-panel on the screen; 1202 denotes a point, which is displayed on (x1, y1) coordinates of the G-panel, displayed on the screen; and 1204 denotes a point, which is displayed on (x2, y2) coordinates of the G-panel, displayed on the screen.

Also, 1201 denotes a display image of the R-panel on the screen; 1203 denotes a point, which is displayed on (x1, y1) coordinates of the R-panel, displayed on the screen; 1205 denotes a point, which is displayed on (x2, y2) coordinates of the R-panel, displayed on the screen; 1206 denotes the rotation center of displacements of the display images of the G-panel and the R-panel; and 1208 denotes a rotational angle.

Regarding reference numbers appearing in FIG. 13, 1201 denotes the R-panel, 1301 denotes an image 1301 inputted after compensation by rotation about the rotation center 1206 and by the rotational angle 1208 in the reverse direction to the rotating direction of the display image 1201 of the R-panel.

For example, in the cases where the upper right part is displaced upwards as shown in FIG. 10 and the lower left part is displaced downwards as shown FIG. 11, when the coordinates of a G-pixel on the G-panel 2G in the corresponding pattern shown in FIG. 9 are given by (x1, y1), an image displayed on the (x1, y1) coordinates of the rotated R-panel 2R is displayed at (x1+Δx, y1+Δy) on the screen as shown by the point 1203 in FIG. 12. When the coordinates of a G-pixel of the pattern shown in FIG. 10 are given by (x2, y2), an image of the rotated R-panel is displayed at (x2−Δx, y2−Δy) of the (x2, y2) coordinates on the screen as shown by the point 1205 in FIG. 12.

The intersection made by a straight line connecting (x1, y1) and (x2, y2) and another straight line connecting (x1+Δx, y1+Δy) and (x2−Δx, y2−Δy) serves as the rotation center.

A rotational angle A is computed by the following expressions:
A=A2−A1 (1),
tanA1=(y1−y0)/(x0−x1) (2), and
tanA2=((y1+Δy)−y0)/(x0−(x1+Δx)) (3).

The R-panel is rotated clockwise by an angle A, relative to the G-panel.

Accordingly, the image 1301 rotated in the reverse direction to the rotation of the display image 1201 of the R-panel can be displayed on the R-panel 2R as shown in FIG. 13.

In the following expressions, an image to be rotated lies at coordinates (x, y), and the above-mentioned image rotated by an angle A lies at coordinates (X, Y). When the rotation center is set at coordinates (x0, y0), the coordinates (x, y) of the image to be rotated, corresponding to the coordinates (X, Y) of the rotated image, can be obtained by the following expressions:
x=((X−x0)×cosA−(Y−y0) sinA)+x0 (4), and
y=((X−x0)×sinA−(Y−y0) cosA)+y0 (5).

The coordinates (X, Y) of the rotated image are computed on the basis of the coordinates (x, y) of the original image in accordance with expressions (4) and (5) and written in the R-panel.

If variables “x” and “y” include fractions below decimal point, an interpolation process such as Nearest Neighbor interpolation, Linear interpolation, or Cubic interpolation can be performed by using circumferential pixels in accordance with the fractions.

When the fixing position of a panel is rotated, the corresponding image rotated in the reverse direction to the rotation direction of the fixing position is displayed.

As described above, by forming an image suitable for a rotated panel on the basis of its original image to be rotated and displaying it, a synthesized image free from displacement is obtained.

While positions of at least two panels in a projection display apparatus are aligned in the adjusting method according to the present embodiment, the present invention is not limited to the projection display apparatus and is applicable to an apparatus in which a plurality of display is synthesized and displayed.

While the display-position compensating section is independently provided from the resolution converting section in the present embodiment, either one may serve also as the other.

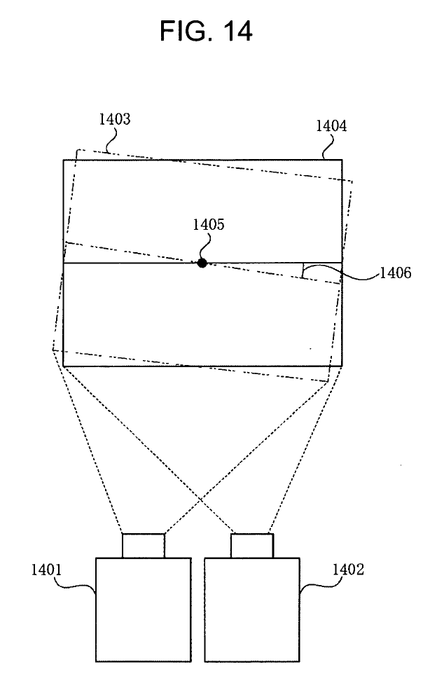

Referring now to FIG. 14, a method for synthesizing images of two projectors will be described.

Images 1403 and 1404 are projected onto a screen (not shown) by front projectors 1401 and 1402, respectively. The projected image 1403 of the projector 1401 is rotated clockwise about a rotation center 1405 by an angle 1406.

In the present embodiment too, a displacement amount of the image 1403 is detected by projecting the adjusting images shown in FIG. 8, and a synthesized image of these images free from displacement is achieved by projecting the image 1403 rotated in the reverse direction to the rotating direction of the corresponding display image, onto the projector 1401.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-314050 filed Oct. 28, 2004, which is hereby incorporated by reference herein in its entirety.

What is claimed is:

1. A display apparatus operable to display images, comprising:
an adjusting-image display unit displaying, on a display frame, position-adjusting-images of a plurality of colors formed in a plurality of different patterns;
a selecting unit facilitating selecting any of the patterns; and
a compensating unit compensating for display displacement of images in accordance with the adjusting images selected by the selecting unit.

2. The display apparatus according to claim 1, further comprising an arranging unit arranging at least two of the adjusting images on opposing corners of the display frame.

3. The display apparatus according to claim 1, wherein the compensating unit includes:
a computing unit computing information regarding display displacement of the images on the basis of a target pixel and circumferential pixels of the target pixel; and
a compensation-pixel forming unit forming a compensation pixel in accordance with the information computed by the computing unit.

4. The display apparatus according to claim 1, further comprising:
a rotational-angle computing section computing a rotational angle on the basis of the at least two selected patterns displayed on the display frame; and
a rotation-compensating display unit compensating for a display image by rotating and displaying the display image.

5. A display method of a display apparatus, comprising the steps of:
displaying position-adjusting-images, on a display frame, of a plurality of colors formed in a plurality of different patterns;
selecting any of the patterns; and
compensating for display displacement of images in accordance with the adjusting images selected by the selecting unit.

6. The display method of a display apparatus according to claim 5, further comprising the step of arranging at least two of the adjusting images on opposing corners of the display frame.

7. The display method of a display apparatus according to claim 5, wherein the compensating step includes the steps of:
computing information regarding display displacement of the images on the basis of a target pixel and circumferential pixels of the target pixel; and
forming a compensation pixel in accordance with the computed information.

8. The display apparatus according to claim 5, further comprising the steps of:
computing a rotational angle on the basis of the at least two selected patterns displayed on the display frame; and
compensating for a display image by rotating and displaying the display image.
